(19) United States
(12) Patent Application Publication
(10) Pub. No.: US 2007/0195032 A1
(43) Pub. Date: Aug. 23, 2007

(54) Touch sensitive display device

(75) Inventors: Joo-Hyung Lee, Gwacheon-si (KR); Jun-Hee Moon, Yongin-si (KR); Sang-Jin Pak, Yongin-si (KR); Young-Joon Choi, Seoul (KR); Myung-Woo Lee, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/706,804

(22) Filed: Feb. 14, 2007

(30) Foreign Application Priority Data
Feb. 17, 2006 (KR) 10-2006-0015480

(51) Int. Cl. G09G 3/36

(52) U.S. Cl. 345/87

(57) ABSTRACT

A liquid crystal display includes a first display panel, a second display panel, a liquid crystal layer, a plurality of sensing data lines formed on the second display panel, a plurality of variable capacitors connected to the sensing data lines and a first voltage of which capacitance is changed depending on pressure, a plurality of reference capacitors connected to the sensing data lines and a second voltage, and a plurality of output units connected to the sensing data lines which generate sensing signals on the basis of sensing data signals that flow through the sensing data lines. The magnitude of the first voltage has a first level and a second level that is different from the first level, and the magnitude of the second voltage is constant. A time period for maintaining the first voltage at the second level in a interval for reading the sensing signal is at least 1H, and the sensing signal is generated while maintaining the first voltage at the second level. Accordingly, a time for outputting the sensing signal is increased and sensitivity of the sensing unit is improved, thereby increasing reliability of the sensing signal.

### CROSS to REFERENCE TO RELATED APPLICATION

This application claims priority to and the benefit of Korean Patent Application No. 10-2006-0015480 filed in the Korean Intellectual Property Office on Feb. 17, 2006, the contents of which are incorporated herein by reference.

### FIELD OF THE INVENTION

The present invention relates to a display having a touch sensitive screen,

### DESCRIPTION OF THE RELATED ART

Among display devices having two closely separated display panels, the liquid crystal display (LCD) device is very popular. In such a device, pixel electrodes, scanning and data electrodes and switching elements are typically provided on one panel and a common electrode is provided on the other panel. A liquid crystal layer having dielectric anisotropy is located between the panels. The pixel electrodes are arranged in a matrix form and connected to switching elements such as thin film transistors (TFTs). Rows of the pixels are scanned and data voltages are applied to scanned rows. A common voltage is applied to the common electrode which is disposed over the entire surface of one of the panels. Each pixel electrode together with the common electrode and the liquid crystal layer constitute a liquid crystal capacitor. A varying electric field applied between the pixel electrode and the common electrode controls the transmittance of light passing through the liquid crystal layer to display an image. However, it is necessary to reverse the polarity of the applied electric field every frame, pixel row, or pixel to avoid damaging the liquid crystal layer.

A touch screen panel is a device for instructing a machine such as a computer to perform a desired command by contacting the touch screen panel with a finger, touch pen, or stylus to write letters, draw a picture or activate an icon. The LCD onto which the touch screen panel is attached determines when and where the screen has been contacted. Manufacturing an LCD with a touch screen panel involves increases cost and possibly decreased throughput as well as yielding a display with reduced luminance. Further, the thickness of the display is increased because of the touch panel.

In order to solve such problems, it has been proposed to embed in the display region a sensing unit that includes a thin film transistor or variable capacitor instead of an external touch screen panel. The sensing unit senses the variation of light or pressure the LCD screen is contacted. The sensing unit includes an array of variable capacitors that determine when and where contact has been made based on the voltage change caused by the change in capacitance of the variable capacitors in the area where the screen is contacted. Since the change in voltage is based on detecting change in the common voltage state, the time for reading the sensing signal is limited, thereby decreasing reliability of the sensing unit.

### SUMMARY OF THE INVENTION

The present invention provides a liquid crystal display having a touch screen liquid crystal display including: a first display panel; a second display panel facing the first display panel and being spaced apart from the first display panel; a liquid crystal layer interposed between the first and second display panels; a plurality of sensing data lines formed on the second display panel; a plurality of variable capacitors connected to the sensing data lines and a first voltage, variable capacitors having a capacitance that is changed depending on pressure; a plurality of reference capacitors connected to the sensing data lines and a second voltage; and a plurality of output units connected to the sensing data lines, the output units generating sensing signals on the basis of sensing data signals that flow through the sensing data lines. The magnitude of the first voltage has a first level and a second level that is different from the first level, the magnitude of the second voltage is constant, the time period for maintaining the first voltage at the second level in the interval for reading the sensing signal is at least 1H, and the sensing signal is generated while maintaining the first voltage at the second level.

In the above aspect of the present invention, the second level may be higher or lower than the first level. In addition, the first voltage may be a common voltage. The interval for reading the sensing signal may be a porch interval. The liquid crystal display may further include a plurality of reset signal input units connected to the sensing data lines, the reset signal input units receiving a reset voltage and applying the reset voltage to the sensing data lines.

The reset signal input units connected to the sensing data lines may each include a first reset switching element which applies the first reset voltage that is input depending on the first reset control signal to the connected sensing data line.

The reset signal input units connected to the sensing data lines may each further include a second reset switching element which applies the second reset voltage that is input depending on the second reset control signal to the connected sensing data line at a different time from that when the first reset voltage is applied.

The liquid crystal display may further include a plurality of output transistors connected to the sensing data lines, each of the output transistors transmitting an output signal generated depending on the sensing data signal that flows through the sensing data line to the corresponding output unit.

According to another aspect of the present invention, there is provided a liquid crystal display including: a first display panel; a second display panel facing the first display panel and being spaced apart from the first display panel; a plurality of pixels formed between the first and second display panels; a plurality of first sensing units formed between the first and second display panels; a plurality of second sensing units formed between the first and second display panels; a plurality of first sensing data lines connected to the first sensing units, the first sensing data lines extending in the horizontal direction on the second display panel; a plurality of second sensing data lines connected to the second sensing units, the second sensing data lines extending in the vertical direction on the second display panel; a plurality of first sensing signal output units formed on the second display panel, the first sensing signal output units converting sensing data signals output from the first sensing data lines; and a plurality of second sensing signal output units formed on the second display panel, the second sensing signal output units converting sensing data signals output from the second sensing data lines, wherein the plurality of first sensing signal output units are formed at the left or right side of the second display panel.

In the above aspect of the present invention, the liquid crystal display may further include a plurality of output data lines connected to the plurality of first sensing signal output units.

The plurality of first sensing signal output units may be vertically disposed in a line.

The plurality of output data lines may extend in the vertical direction.

The plurality of output data lines may extend between respective adjacent pixels in the horizontal direction with different lengths and then extend in the vertical direction. The adjacent first sensing signal output units may be vertically disposed in a horizontally shifted manner at predetermined intervals.

The plurality of output data lines may extend in the vertical direction.

The sensing units may each include a variable capacitor of which capacitance is changed depending on pressure and a reference capacitor connected to the sensing data line and the second voltage.

### BRIEF DESCRIPTION OF THE DRAWING

The foregoing and other objects, features and advantages of the present invention will become more apparent from the ensuing description when read together with the drawing, in which:

FIG. 1 is a block diagram showing a liquid crystal display from a pixel point of view according to an embodiment of the present invention;

FIG. 2 is an equivalent circuit diagram showing a pixel of a liquid crystal display according to another embodiment of the present invention;

FIG. 3 is a block diagram showing a liquid crystal display from a sensing unit point of view according to another embodiment of the present invention;

FIG. 4 is an equivalent circuit diagram showing a sensing unit of a liquid crystal display according to another embodiment of the present invention;

FIG. 5 is a schematic diagram showing a liquid crystal display according to another embodiment of the present invention;

FIG. 6A is an equivalent circuit diagram showing a plurality of sensing units connected to a sensing data line in a liquid crystal display according to another embodiment of the present invention;

FIG. 6B is an equivalent circuit diagram schematically showing FIG. 6A;

FIG. 7 is a timing diagram for a sensing operation of a liquid crystal display according to another embodiment of the present invention;

FIG. 8 is a waveform diagram of various common voltages for reading a sensing signal of a contact sensing unit and sensed signals dependent on the common voltages according to an embodiment of the present invention;

FIG. 9 is a waveform diagram of various common voltages for reading a sensing signal of a contact sensing unit and sensing signals dependent on the common voltages according to another embodiment of the present invention; and

FIGS. 10 to 12 show various examples in which horizontal output data lines OY₁ to OY_{N} and sensing signal output units connected thereto are disposed according to another embodiment of the present invention.

### DETAILED DESCRIPTION

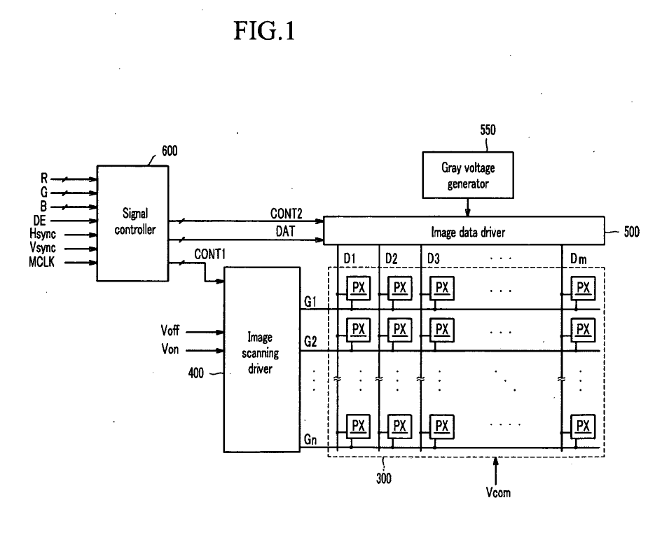

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present. Hereinafter, a liquid crystal display according to an embodiment of the present invention will be described in detail with reference to FIGS. 1 to 5.

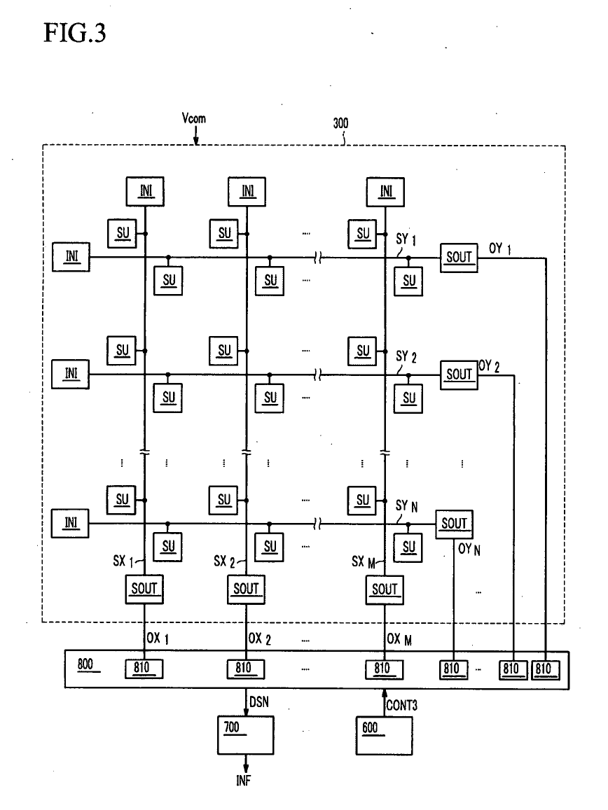

Referring to FIGS. 1 and 3, the liquid crystal display according to an embodiment of the present invention includes a liquid crystal panel assembly 300, an image scanning driver 400 connected to the liquid crystal panel assembly 300, an image data driver 500, a sensing signal processor 800, a gray voltage generator 550 connected to the image data driver 500, a contact determiner 700 connected to the sensing signal processor 800, and a signal controller 600 for controlling the aforementioned elements.

Referring to FIGS. 1 to 4, the liquid crystal panel assembly 300 includes a plurality of display signal lines G₁ to Gₙ and D₁ to Dₘ; a plurality of pixels PX arranged substantially in a matrix form and connected to display signal lines G₁ to Gₙ and D₁ to Dₘ; a plurality of sensing signal lines SY₁ to SY_{N}, SX₁ to SX_{M}, and RL; a plurality of sensing units SU arranged substantially in a matrix form and connected to the sensing signal lines SY₁ to SY_{N}, SX₁ to SX_{M}, and RL; a plurality of initial signal input units INI respectively connected to one end of each of the sensing signal lines SY₁ to SY_{N} and SX₁ to SX_{M}; a plurality of sensing signal output units SOUT respectively connected to the other end of each of the sensing signal lines SY₁ to SY_{N} and SX₁ to SX_{M}; and a plurality of output data lines OY₁ to OY_{N} and OX₁ to OX_{M} connected to the sensing signal output units SOUT.

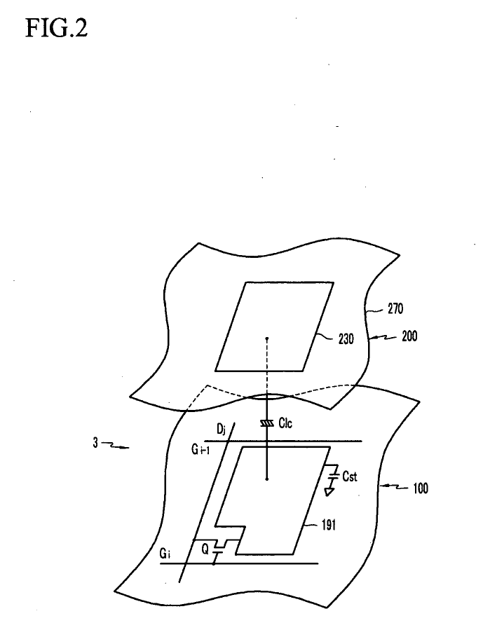

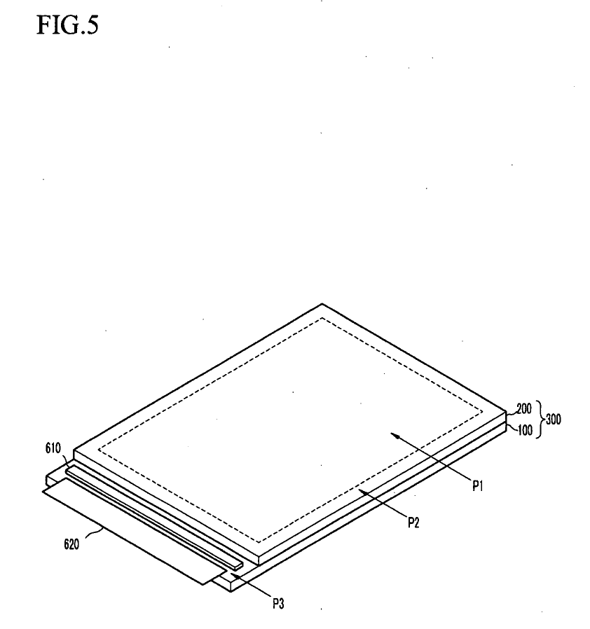

Referring to FIGS. 2 and 5, the liquid crystal panel assembly 300 further includes a thin film transistor array panel 100 and a common electrode panel 200 that faces thin film transistor array panel 100, a liquid crystal layer 3 interposed therebetween. A compressible spacer (not shown) maintains a gap between the two display panels 100 and 200.

Display signal lines G₁ to Gₙ and D₁ to Dₘ include a plurality of image scanning lines G₁ to Gₙ for transmitting image scanning signals and a plurality of image data lines D₁ to Dₘ for transmitting image data signals. The sensing signal lines SY₁ to SY_{N}, SX₁ to SX_{M}, and RL include a plurality of horizontal sensing data lines SY₁ to SY_{N} for transmitting sensing data signals, a plurality of vertical sensing data lines SX₁ to SX_{M}, and a plurality of reference voltage lines RL for transmitting a reference voltage. The reference voltage lines RL may be omitted at necessary.

The image scanning lines G₁ to Gₙ and the horizontal sensing data lines SY₁ to SY_{N} extend substantially in the row direction and are substantially parallel to one another. The image data lines D₁ to Dₘ and the vertical sensing data lines SX₁ to SX_{M} extend in the column direction and are substantially parallel to each other. The reference voltage lines RL extends in the row or column direction.

Each pixel PX includes a display switching element Q connected to signal lines G₁ to Gₙ and D₁ to Dₘ, a liquid crystal capacitor Clc connected to the display switching element, and a storage capacitor Cst. Storage capacitor Cst may be omitted as necessary.

Switching element Q is a three-terminal element such as a thin film transistor in thin film transistor array panel 100. A control terminal of switching element Q is connected to the corresponding image scanning lines G₁ to Gₙ. An input terminal of switching element Q is connected to the corresponding image data lines D₁ to Dₘ, and an output terminal is connected to liquid crystal capacitor Clc and storage capacitor Cst. Thin film transistor includes amorphous silicon or polysilicon.

Liquid crystal capacitor Clc has two terminals, pixel electrode 191 of thin film transistor array panel 100 and common electrode 270 of common electrode panel 200. Liquid crystal layer 3 that is interposed between the two electrodes 191 and 270 functions as a dielectric.

Pixel electrode 191 is connected to switching element Q. Common electrode 270 is disposed over the entire surface of the common electrode panel 200 and is supplied with a common voltage, Vcom. Unlike FIG. 2, common electrode 270 may be included in thin film transistor array panel 100 and, if so, at least one of the two electrodes 191 and 270 may be formed in a linear or bar shape.

Storage capacitor Cst which functions as an auxiliary capacitor of the liquid crystal capacitor Clc is formed by overlapping a separate signal line (not shown) in thin film transistor array panel 100 and a pixel electrode 191 with an insulating layer in between. The separate signal line is supplied with a predetermined voltage such as the common voltage Vcom. Storage capacitor Cst may be formed by overlapping pixel electrode 191 and the immediately upper image scanning line with an intervening insulator.

In order to provide a color display, each pixel PX uniquely displays one of primary colors (spatial division) or alternately displays the primary colors with respect to time (temporal division). Accordingly, a desired color is recognized by a spatial or temporal sum of the primary colors. The primary colors may be the three primary colors red, green, and blue. FIG. 2 shows an example of spatial division in which each pixel PX includes a color filter 230 that displays one of the primary colors in the region of the common electrode panel 200 corresponding to pixel electrode 191. Unlike what is shown in FIG. 2, the color filter 230 may be formed over or under pixel electrode 191 of thin film transistor array panel 100. One or more polarizers (not shown) that polarize light are attached to an outer surface of the liquid crystal panel assembly 300.

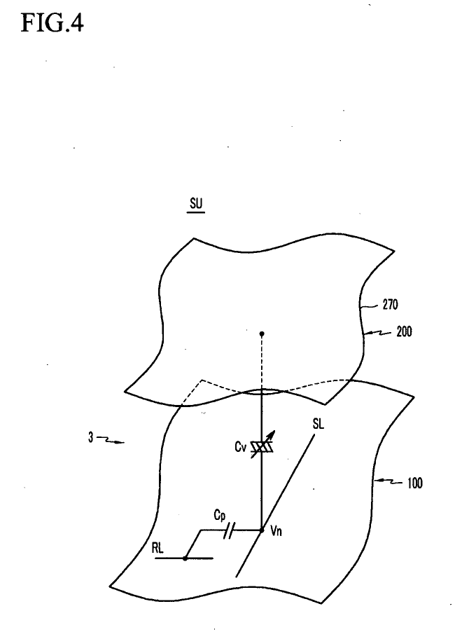

As shown in FIG. 4, sensing unit SU includes a variable capacitor Cv connected to the horizontal or vertical sensing data line (hereinafter, referred to as a sensing data line) designated by reference characters SL, and a reference capacitor Cp connected between the sensing data line SL and the reference voltage line RL.

Reference capacitor Cp is formed by overlapping the reference voltage line RL of thin film transistor array panel 100 and the sensing data line SL through the insulator (not shown).

Variable capacitor Cv has two terminals which are the sensing data line SL of thin film transistor array panel 100 and the common electrode 270 of the common electrode panel 200. The liquid crystal layer 3 that is interposed between the two terminals functions as a dielectric. The capacitance of variable capacitor Cv varies depending on an external stimulus such as the user's touching the screen area P1 (FIG. 5) of liquid crystal panel assembly 300. When such a pressure is applied to common electrode panel 200, the spacer is compressed to change a distance between the two terminals, thereby changing the capacitance of variable capacitor Cv. When the capacitance of variable capacitor Cv is changed, the magnitude of the contact voltage Vn between reference capacitor Cp and variable capacitor Cv which is dependent on the capacitance magnitude of variable capacitor Cv is changed. The contact voltage Vn is the sensing data signal, and it flows through the sensing data line SL. Whether or not there is contact with the LCD screen area P1 is determined on the basis of the contact voltage Vn. Since reference capacitor Cp has a fixed capacitance, and the reference voltage applied to reference capacitor Cp has a specific voltage value, the contact voltage Vn varies within a specific range and, accordingly, the sensing data signal voltage level varies within a specific range, It is thus it easy to determine whether of not contact with the screen exists and to easily determine the contact location.

The sensing unit SU is disposed between two adjacent pixels PX. The density of sensing units SU that are connected to the horizontal and vertical sensing data lines SY₁ to SY_{N} and SX₁ to SX_{M} and located near the crossing region of the horizontal and vertical sensing data lines is, for example, about ¼ that of the dot pitch. A single dot includes three pixels PX arranged in parallel to one another and can display the three primary colors of red, green, and blue. The single dot displays one color and is a basic unit of a resolution of the liquid crystal display. However, a single dot may include four or more pixels PX. In this case, each pixel PX may display one of the three primary colors or white.

An example in which the density of the pairs of the sensing units SU is ¼ of the dot pitch exists where the horizontal and vertical resolution of pairs of sensing units SU are respectively ½ of the horizontal and vertical resolution of the liquid crystal display. In the aforementioned case, there may be a pixel row and a pixel column to which the sensing unit SU is not connected. When the density of the sensing units SU and the dot pitch are adjusted to the aforementioned degree, the liquid crystal display may be applied to a field such as a character recognition field in which high accuracy is required. The resolution of the sensing unit SU may be higher or lower than the aforementioned value as desired.

As described above, since the space occupied by the sensing unit SU and the sensing data line SL is relatively small, the reduction of pixel aperture ratio is minimized.

The plurality of reset signal input units INI have the same structure, and a plurality of sensing signal output units SOUT also have the same structure. Hereinafter, the structure and operation of the reset signal input units INI and the sensing signal output units SOUT will be described in detail.

Output data lines OY₁ to OY_{N} and OX₁ to OX_{M} include a plurality of horizontal and vertical output data lines OY₁ to OY_{N} and OX₁ to OX_{M} respectively connected to the horizontal and vertical sensing data lines SY₁ to SY_{N} and SX₁ to SX_{M} through the corresponding sensing signal output unit SOUT. Output data lines OY₁ to OY_{N} and OX₁ to OX_{M} are connected to the sensing signal processor 800, and transmit output signals from the sensing signal output units SOUT to the sensing signal processor 800. The horizontal and vertical output data lines OY₁ to OY_{N} and OX₁ to OX_{M} extend substantially in the column direction and are substantially in parallel with one another.

Referring to FIGS. 1 and 3 again, gray voltage generator 550 generates two sets of gray voltage groups (or reference gray voltage groups) that are related to pixel light transmittance. One of the two gray voltage sets has a positive value and the other set has a negative value with respect to the common voltage Vcom.

Image scanning driver 400 is connected to the image scanning lines G₁ to Gₙ. The image scanning driver 400 applies to the image scanning lines G₁ to Gₙ an image scanning signal obtained by combining a gate-on voltage Von to turn on switching element Q and a gate-off voltage Voff to turn off switching element Q.

Image data driver 500 is connected to the image data lines D₁ to Dₘ. The image data driver 500 selects a gray voltage output from the gray voltage generator 550 and applies the selected gray voltage to the image data lines D₁ to Dₘ as the image data signal. However, when the gray voltage generator 550 does not provide the voltage for all the grays but rather supplies a predetermined number of reference gray voltages, the image data driver 500 generates the gray voltages for all gray levels by dividing the reference gray voltages and selects the image data signal from among the generated gray voltages.

Sensing signal processor 800 includes a plurality of amplifying units 810 connected to the output data lines OY₁ to OY_{N} and OX₁ to OX_{M}. The sensing signal processor 800 receives output signals from each amplifying unit 810, processes the received signals, for example by amplification and so on, to generate an analogue sensing signal Vo, and converts the analogue sensing signal Vo into a digital signal by using an analogue-digital converter (not shown) to generate a digital sensing signal DSN.

The contact determiner 700 determines whether the LCD is touched, determines the contact location, and outputs the contact information INF to an external device by receiving and processing the digital sensing signal DSN from the sensing signal processor 800. Contact determiner 700 monitors the operation of sensing unit SU on the basis of the digital sensing signal DSM, thereby controlling the signal applied thereto.

Signal controller 600 controls operations of the image scanning driver 400, the image data driver 500, the gray voltage generator 550, the sensing signal processor 800, and so forth.

Each of the driving devices 400, 500, 550, 600, 700, and 800 may be directly mounted on the liquid crystal panel assembly 300 as one or more IC chips, may be attached to the liquid crystal panel assembly 300 as a tape carrier package (TCP) in which each driving device is mounted on a flexible printed circuit film (not shown), or may be mounted on a separate printed circuit board (PCB) (not shown). Unlike the aforementioned structure, the driving devices 400, 500, 550, 600, 700, and 800 may be integrated into the liquid crystal panel assembly 300 together with the signal lines G₁ to Gₙ, D₁ to Dₘ, SY₁ to SY_{N}, SX₁ to SX_{M}, OY₁ to OY_{N}, OX₁ to OX_{M}, and RL, thin film transistor Q, and so forth.

Referring to FIG. 5, the liquid crystal panel assembly 300 is divided into a display region P1, an edge region P2, and an exposed region P3. Pixels PX, sensing units SU, and signal lines G₁ to Gₙ, D₁ to Dₘ, SY₁ to SY_{N}, SX₁ to SX_{M}, OY₁ to OY_{N}, OX₁ to OX_{M}, and RL are mostly located in the display region P1. The common electrode panel 200 includes light blocking members (not shown) such as black matrices, and the light blocking members cover most of the edge region P2 to shield light from the outside. Since the common electrode panel 200 is smaller than thin film transistor array panel 100, a part of thin film transistor array panel 100 is exposed to form the exposure region P3. A single chip 610 is mounted on the exposure region P3, and a flexible printed circuit board (FPC substrate) 620 is attached onto the exposed region P3.

Single chip 610 includes the driving devices for driving the liquid crystal display, that is, image scanning driver 400, image data driver 500, gray voltage generator 550, signal controller 600, contact determiner 700, and sensing signal processor 800. It is possible to reduce the mounting area and power consumption by integrating the driving devices 400, 500, 550, 600, 700, and 800 into the single chip 610. One or more driving devices or one or more circuit elements that constitute the driving device may be located outside the single chip 610, at need.

The image signal lines G₁ to Gₙ and D₁ to Dₘ and the output data lines OY₁ to OY_{N} and OX₁ to OX_{M} extend to the exposure region P3 to be connected to the corresponding driving devices 400, 500, and 800.

The flexible printed circuit (FPC) substrate 620 receives a signal and transmits the signal to the single chip 610 or to the liquid crystal panel assembly 300. In general, an end of FPC substrate 620 includes a connector (not shown) in order to be easily connected to an external device.

Hereinafter, the display operation and the sensing operation of the liquid crystal display will be described in detail.

Signal controller 600 receives input image signals R, G, and B and an input control signal for controlling display of the input image signals R, G, and B from an external device (not shown). The input image signals R, G, and B include luminance information of each pixel PX, and the luminance information includes a predetermined number, for example, 1024 (=2¹⁰), 256 (=2⁸) or 64 (=2⁶), of grays. Examples of the input control signal are a vertical synchronization signal Vsync, a horizontal synchronizing signal Hsync, a main clock signal MCLK, a data enable signal DE, and so forth.

Signal controller 600 processes the input image signals R, G, and B on the basis of the input image signals R, G, and B and the input control signal to satisfy operating conditions of the liquid crystal panel assembly 300 and the image data driver 500, generates an image scan control signal CONT1, an image data control signal CONT2, a sensing data control signal CONT3, and so forth, outputs the image scan control signal CONT1 to the image scanning driver 400, outputs an image signal DAT that is processed with the image data control signal CONT2 to the image data driver 500, and outputs the sensing data control signal CONT3 to the sensing signal processor 800.

The image scan control signal CONT1 includes a scanning start signal STV for instructing the image scanning driver 400 to start scanning, and one or more clock signals for controlling the output of gate-on voltage Von. The image scan control signal CONT1 may further include an output enable signal OE for limiting the duration of the gate-on voltage Von.

The image data control signal CONT2 includes a horizontal synchronization start signal STH for indicating the start of the transmission of the image data DAT of a single pixel row, a load signal LOAD for instructing the image data signal to be applied to the image data lines D₁ to Dₘ, and a data clock signal HCLK. The image data control signal CONT2 may further include an inversion signal RVS for inverting the voltage polarity of the image data signal with respect to the common voltage Vcom (hereinafter, the voltage polarity of the image data signal with respect to the common voltage is abbreviated to “polarity of the image data signal”).

According to the image data control signal CONT2 from the signal controller 600, image data driver 500 receives the digital image signals DAT of pixels PX of a single pixel row, selects the gray voltage corresponding to each digital image signal DAT, converts the digital image signal DAT into an analog image data signal, and applies the analogue image data signal to the corresponding image data lines D₁ to Dₘ.

The image scanning driver 400 applies the gate-on voltage Von to the image scanning lines G₁ to Gₙ according to the image scan control signal CONT1 from the signal controller 600, thereby turning on switching element Q connected to the image scanning lines G₁ to Gₙ. Then, the image data signal applied to the image data lines D₁ to Dₘ is applied to the corresponding pixels PX through the turned-on switching element Q.

The difference between the voltage of the image data signal applied to the pixels PX and the common voltage Vcom is the charging voltage of the liquid crystal capacitor Clc, that is, the pixel voltage. The liquid crystal molecules are differently arranged depending on the magnitude of the pixel voltage and change the polarization of light passing through the liquid crystal layer 3. The polarization change induces a change of transmittance of light through the polarizer attached to the liquid crystal panel assembly 300, thereby displaying a desired image.

The aforementioned procedures are repeated in units of one horizontal period (or “1H” which is one period of the horizontal synchronization signal Hsync and the data enable signal DE) and, accordingly, the gate-on voltage Von is sequentially applied to all the gate lines G₁ to Gₙ for one frame, thereby applying the data voltage to all the pixels to display one frame of the image. The next frame is started after one frame is ended, and the status of the inversion signal RVS supplied to the image data driver 500 is controlled so that the polarities of the image data signals applied to the respective pixels are inverted for every frame (“frame inversion”). Alternatively, the polarity of the image data signals supplied through one data line may be inverted within one frame by, for example, using row inversion or dot inversion or the polarities of the image data signals supplied to the pixels in one row may be opposite to each other (for example, column inversion, dot inversion), depending upon the characteristic of the inversion signal RVS.

The sensing signal processor 800 reads the sensing data signals applied through the output data lines OY₁ to OY_{N} and OX₁ to OX_{M} in a porch interval between successive frames according to the sensing data control signal CONT3. In the porch interval, the sensing data signal is less influenced by the driving signal from the image scanning driver 400 and the image data driver 500, and accordingly, reliability of the sensing data signal is increased. The reading operation does not need to be performed every frame, and it may be performed once in a plurality of frames, as necessary. The reading operation may be performed twice or more in the porch interval, or it may be performed once or more in a frame.

Then, the sensing signal processor 800 amplifies the read analog sensing data signals by using respective amplifying units 810, converts the amplified signals into the digital sensing signals DSN, and outputs the converted signal to the contact determiner 700. Hereinafter, an operation of each amplifying unit 810 of the sensing signal processor 800 will be described in detail.

The contact determiner 700 determines whether the LCD is touched, determines the contact location, and outputs the contact information INF to an external device by receiving and processing the digital sensing signal DSN. The external device transmits the image signal R, G, and B based on the contact information INF to the LCD, and the LCD displays images selected by the user.

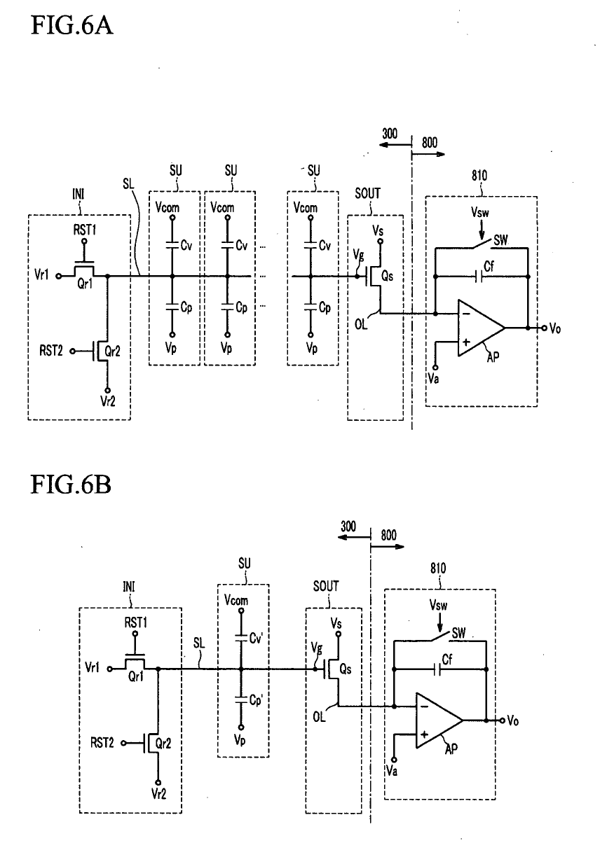

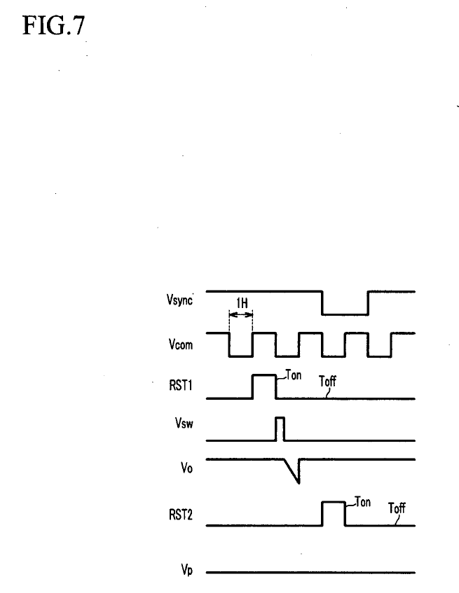

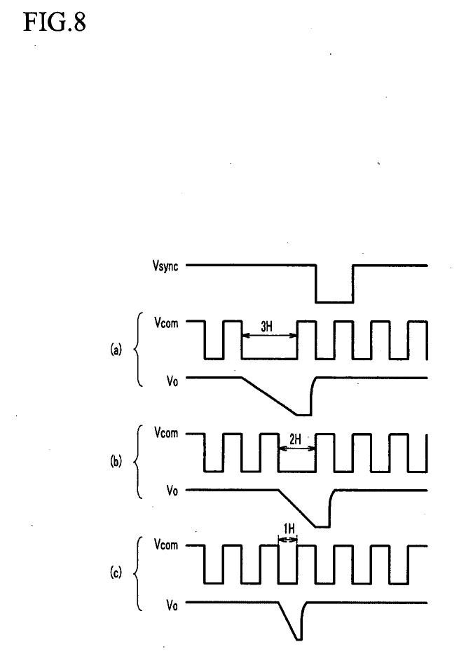

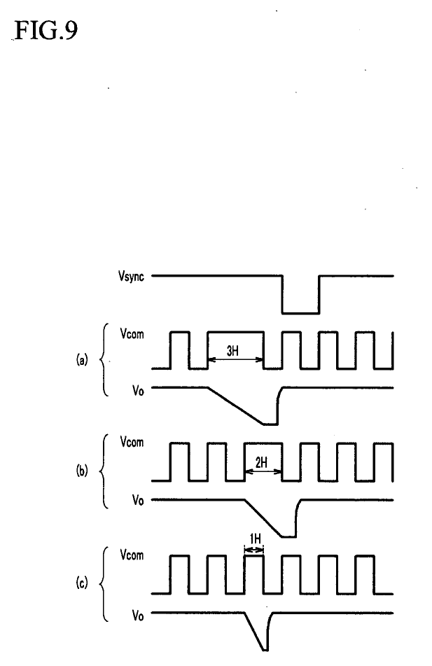

Next, referring to FIGS. 6A to 9, structures and operations of the reset signal input unit INI, the sensing signal output unit SOUT, and the amplifying unit 810 according to an embodiment of the present invention will be described. FIG. 6A is an equivalent circuit diagram showing a plurality of sensing units connected to a sensing data line in a liquid crystal display according to another embodiment of the present invention, and FIG. 6B is an equivalent circuit diagram schematically showing FIG. 6A. FIG. 7 is a timing diagram for a sensing operation of the liquid crystal display according to another embodiment of the present invention. FIG. 8 is a waveform diagram of various common voltages for reading the sensing signal of the contact sensing unit and sensed signals, and FIG. 9 is a waveform diagram of various common voltages for reading the sensing signal of the contact sensing unit and sensed signals according to another embodiment of the present invention.

Referring to FIGS. 6A and 6B, as described above in reference to FIG. 3, the liquid crystal panel assembly 300 includes a plurality of sensing data lines SL (in FIG. 3, SY₁ to SY_{N}, SX₁ to SX_{M}), a plurality of sensing units SU connected to the sensing data lines SL, reset signal input units INI respectively connected to one end of each of the sensing data lines SL, and a plurality of sensing signal output units SOUT respectively connected between the sensing data lines SL and the other end of each of the output data lines OL (in FIG. 3, OY₁ to OY_{N} and OX₁ to OX_{M}). In addition, as described in FIG. 3, the sensing signal processor 800 includes the plurality of amplifying units 810 connected to the output data lines OL.

In particular, a plurality of sensing units SU each including a variable capacitor Cv and a reference capacitor Cp are connected to a single sensing data line SL. One end of each of the sensing data lines is connected to the reset signal input units INI, and the other end of each sensing data line is connected to the sensing signal output units SOUT. Variable capacitor Cv is connected to the common voltage Vcom, and reference capacitor Cp is connected to the reference voltage Vp.

As described above, since a plurality of variable capacitors Cv each includes two terminals that are the sensing data line SL and the common electrode 270, the plurality of variable capacitors Cv can be replaced by an equivalent variable capacitor Cv′ as shown in FIG. 6B. In practice, the capacitance of variable capacitor Cv′ is uniformly distributed along the single sensing data line SL. As shown in FIG. 6B, like variable capacitor Cv′, the plurality of reference capacitors Cp can also be replaced by an equivalent reference capacitor Cp′.

Each reset signal input unit INI includes first and second reset transistors Qr1 and Qr2. The first and second reset transistors Qr1 and Qr2 are three-terminal elements such as thin film transistors. The control terminals of the first and second reset transistors Qr1 and Qr2 are respectively connected to first and second reset control signals RST1 and RST2. The input terminals of the first and second reset transistors Qr1 and Qr2 are respectively connected to first and second reset voltages Vr1 and Vr2, and the output terminals of the first and second reset transistors Qr1 and Qr2 are connected to the sensing data lines SL.

The first and second reset transistors Qr1 and Qr2 that are located on the edge region P2 of the liquid crystal panel assembly 300 provide the first and second reset voltages Vr1 and Vr2 for the corresponding sensing data line according to the first and second reset control signals RST1 and RST2.

Each sensing signal output unit SOUT includes an output transistor Qs. The output transistor Qs is also a three-terminal element such as a thin film transistor. The control terminal of the output transistor Qs is connected to the sensing data line SL. The input terminal of the output transistor Qs is connected to the input voltage Vs, and the output terminal of the output transistor Qs is connected to the output data line OL. The output transistor Qs that is located on the edge region P2 of the liquid crystal panel assembly 300 generates the output signal on the basis of the sensing data signal that flows through the sensing data line SL. The output signal may be an output current. Alternatively, the output transistor Qs generates a voltage as the output signal.

Each amplifying unit 810 includes an amplifier AP, a capacitor Cf, and a switch SW.

Amplifier AP includes an inversion terminal (−), a non-inversion terminal (+), and an output terminal. The inversion terminal (−) is connected to the output data line OL, the capacitor Cf and the switch SW are connected between the inversion terminal (−) and the output terminal, and the non-inversion terminal is connected to the reference voltage Va. The amplifier AP and the capacitor Cf constitute a current integrator, and the current integrator integrates the output current from the output transistor Qs for a predetermined time, thereby generating the sensing signal Vo.

Referring to FIG. 7, as described above, the liquid crystal display performs the sensing operation in a porch interval between two frames, and more preferably in a front porch interval followed by the vertical synchronization signal Vsync.

The common voltage Vcom has high and low levels and swings between the high and low levels every 1H.

As shown in FIG. 7, the first and second reset control signals RST1 and RST2 include turn-on voltages Ton for respectively turning on the first and second reset transistors Qr1 and Qr2 and turn-off voltages Toff for respectively turning off the first and second reset transistors Qr1 and Qr2. Although it is stated that the turn-on voltage Ton is the gate-on voltage Von and the turn-off voltage Toff is the gate-off voltage Voff, the turn-on and turn-off voltages may be other voltages.

As shown in FIG. 7, the sensing operation is advantageously performed when the common voltage Vcom is maintained at the low level.

First, the turn-on voltage Ton of the first reset control signal RST1 is applied when the common voltage is at the high level.

When the turn-on voltage Ton is applied to the first reset transistor Qr1, the first reset transistor Qr1 is turned on, and the first reset voltage Vr1 applied to the input terminal is applied to the sensing data line SL to initialize the sensing data line SL. When the operation is started, and the reference voltage Va is applied to the amplifying unit 810, the capacitor Cf of the amplifying unit 810 is charged by the reference voltage Va, and the magnitude of the output voltage Vo is the same as the reference voltage Va.

When the first reset control signal RST1 is the turn-off voltage, the sensing data line SL goes into a floating state, and the voltage applied to the control terminal of the output transistor Qs is changed depending on the capacitance change of variable capacitor Cv′ and the change of the common voltage Vcom. The current of the sensing data signal that flows through the output transistor Qs is changed depending on the aforementioned voltage change.

Then, the voltage Vg applied to the control terminal of the output transistor Qs is calculated by Equation 1 as follows.

$$Vg = Vr1 - \frac{{Cp}^{′}}{{Cv}^{′} + {Cp}^{′}} ( VH - VL ) \qquad Equation 1$$

where VH is the common voltage value at the high level, VL is the common voltage value at the low level, Cp′ is the capacitance of reference capacitor, and Cv′ is the capacitance of variable capacitor.

As shown in Equation 1, the voltage Vg applied to the control terminal of the output transistor Qs is dependent on the capacitance changes of the capacitors Cp′ and Cv′ and the change of the common voltage Vcom. Therefore, when the sensing unit SU is touched by a user, the distance between the two display panels 100 and 200 is reduced to change the capacitance of variable capacitor Cv′ and the level of the common voltage, and accordingly, a corresponding amount of current flows through the output data line OL via output transistor Qs.

When the first reset signal RST1 is changed to the gate-off voltage Voff, switching signal Vsw is applied to switch SW discharging the voltage charged on capacitor Cf.

After a predetermined time, sensing signal processor 800 reads the sensing signal Vo. The time when the sensing signal Vo is read may be set within 1H after the first reset control signal RST1 becomes the turn-off voltage Voff. That is, the sensing signal Vo may be read before the common voltage Vcom is again changed to the high level. This is because the sensing signal Vo is also changed depending on the level of the common voltage.

Since the sensing data signal is changed with reference to the first reset voltage Vr1, the sensing data signal has a voltage level with a constant range, and accordingly, it is easily determined whether the LCD is contacted and the contact location.

After the sensing signal processor 800 reads the sensing signal Vo, the second reset control signal RST2 becomes the turn-on voltage (Ton), thereby turning on the second reset transistor Qr2. Accordingly, the second reset voltage Vr2 is applied to the sensing data line SL, and then, since the second reset voltage Vr2 is ground voltage, sensing data line SL is reset to ground voltage. The second reset voltage Vr2 is maintained until the first reset voltage Vr2 is applied to the sensing data line SL. Therefore, since the output transistor Qs is maintained off until the next first reset voltage Vr2 is applied, power consumption caused by unnecessary operations is reduced.

In addition, the second reset voltage Vr2 and the common voltage Vcom generate an electric field in the liquid crystal layer interposed between the sensing data line SL and the common electrode 270. The slope direction of the liquid crystal molecules interposed between the sensing data line SL and the common electrode 270 is determined depending on the electric field. Since the change of the slope direction of the liquid crystal molecules is dependent on the change of the sensing data signal, the change of the sensing data signal is increased by setting the second reset voltage Vr2 to a suitable value, thereby improving the sensitivity of the sensing unit SU.

The turn-on voltage Ton of the first reset control signal RST1 may be applied when the common voltage Vcom is at the low level. Then, the sensing signal Vo is read before the common voltage Vcom is changed to the low level again after being changed to the high level. In addition, the first reset control signal RST1 may be synchronized with the image scanning signal applied to the last image scanning line Gₙ.

The second reset control signal RST2 may become the turn-on voltage Ton within 1H just after the sensing signal Vo is read, or may become the turn-on voltage Ton within the next H1.

The reading operation of reading the sensing signal Vo may be performed for a predetermined number of horizontal periods in addition to 1H. That is, the time for reading the sensing signal Vo may be controlled by changing the output waveform of the common voltage Vcom in the porch interval.

For this, when the operation of reading the sensing signal Vo is performed at the low level of the common voltage Vcom, as shown in FIG. 8, the common voltage Vcom is maintained at the low level for a desired number of horizontal periods such as 2H or 3H in addition to 1H, in the porch interval.

Accordingly, while the common voltage Vcom is maintained at the low level, the integration operation of the amplifying unit 810 is performed, thereby outputting the voltage of the integration result as the sensing signal Vo. As the time for reading the sensing signal increases, the integration time increases, thereby increasing the time for reaching the target magnitude when the contact sensing unit SU operates. Accordingly, a negative influence on the sensing signal Vo due to a noise is reduced to improve the sensitivity of the sensing unit.

As shown in FIG. 9, when the operation of reading the sensing signal Vo is performed at the high level of the common voltage Vcom, the common voltage Vcom is maintained at the high level for a predetermined number of horizontal periods such as 2H or 3H in addition to 1H, in the porch interval, thereby reading the sensing signal Vo. Accordingly, as shown in FIG. 8, as the time while the common voltage Vcom is maintained at the high level increases, the integration time of the amplifying unit 810 increases, thereby reducing the negative influence on the sensing signal Vo due to the noise to improve the sensitivity of the sensing unit.

As described above, since the waveform of the common voltage Vcom for reading the sensing signal Vo is changed in the porch interval where normal scanning operation is not performed, the waveform change of the common voltage Vcom does not influence the display operation of the pixels.

The operation of reading the sensing signal may be performed within a predetermined time after the waveform of the common voltage Vcom is changed to a desired state such as the low or high level. Specifically, since the slope of the common voltage Vcom is dependent on the gray of the image data such as image data displayed when a black gray is displayed and image data displayed when a white gray is displayed, the operation of reading the sensing signal Vo may be performed after the common voltage Vcom that swings every predetermined period is maintained at a stable state.

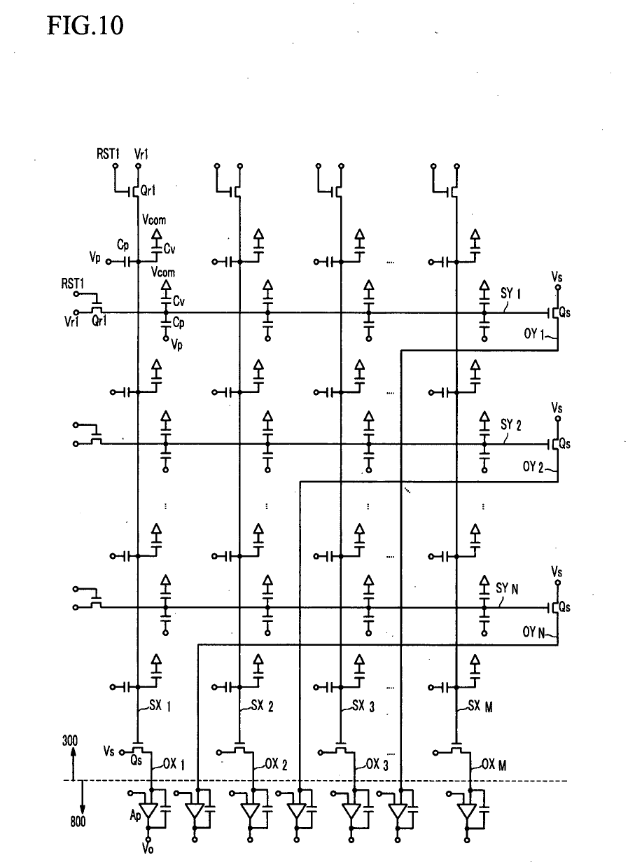

Next, referring to FIGS. 10 to 12, various examples in which the sensing signal output units SOUT and the output data lines OY₁ to OY_{N} are disposed are shown.

Referring to FIG. 3 again, the sensing signal output units SOUT and the horizontal output data lines OY₁ to OY_{N} connected thereto are vertically disposed in line at one side, for example at the right side of the liquid crystal panel assembly 300. In addition, a structure in which the horizontal output data lines OY₁ to OY_{N} connected to the sensing signal output units SOUT are substantially vertically disposed to be connected to the sensing signal processor 800 is shown. Unlike the structure shown in FIG. 3, it is possible that the sensing signal output units SOUT are vertically disposed in line at the left side of the liquid crystal panel assembly 300, and then the horizontal output data lines OY₁ to OY_{N} connected to the sensing signal output units SOUT are disposed.

In FIG. 10, the sensing signal output units SOUT are disposed at one side, for example the right side of the liquid crystal panel assembly 300, and the horizontal output data lines OY₁ to OY_{N} connected to the sensing signal output units SOUT traverse the display region with a predetermined width and extend in the vertical direction. Accordingly, the amplifying units 810 connected to the vertical output data lines OX₁ to OX_{M} and the amplifying units connected to the horizontal output data lines OX₁ to OX_{M} are alternately disposed. Although the first horizontal output data line OY₁ extended in the horizontal direction is shortest in FIG. 10, the last horizontal output data line OY_{N} may be shortest. In addition, although the amplifying units 810 connected to the vertical output data lines OX₁ to OX_{M} are firstly disposed with respect to the amplifying units 810 connected to the horizontal output data lines OY₁ to OY_{N}, the amplifying units 810 connected to the horizontal output data lines OY₁ to OY_{N} may be firstly disposed with respect to the amplifying units 810 connected to the vertical output data lines OX₁ to OX_{M}. The aforementioned disposition of the horizontal output data lines OY₁ to OY_{N} may also be applied to the case where the sensing signal output units SOUT connected to the horizontal output data lines OY₁ to OY_{N} are disposed at the left side of the liquid crystal panel assembly 300.

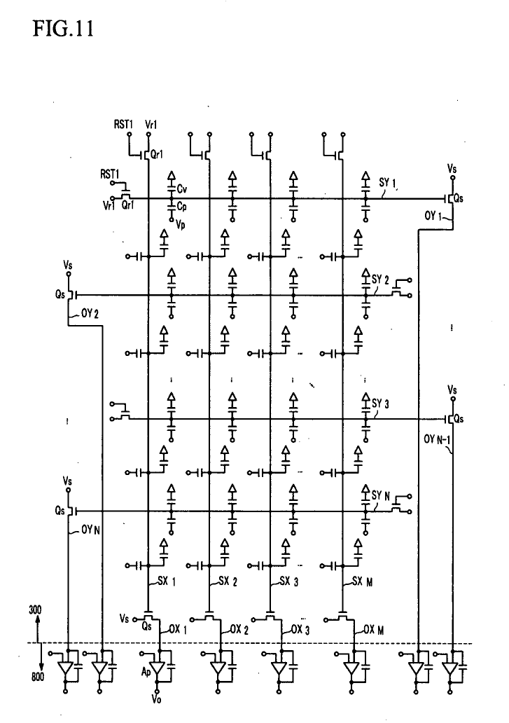

In FIG. 11, an example in which the sensing signal output units SOUT and the horizontal output data lines OY₁ to OY_{N} connected thereto are disposed at the left side and the right side of liquid crystal display panel assembly 300 is shown. For example, odd-numbered horizontal output data lines OY₁, OY₃, . . . and the sensing signal output units SOUT connected thereto are disposed at the right side of the liquid crystal panel assembly 300, and even-numbered horizontal output data lines OY₂, OY₄, . . . and the sensing signal output units SOUT connected thereto are disposed at the left side of the liquid crystal panel assembly 300. Unlike the aforementioned example, the horizontal output data lines OY₁ to OY_{N} and the sensing signal output units SOUT may be disposed at the reverse sides.

As shown in FIGS. 3, 10, and 11, when the sensing signal output units SOUT are vertically disposed in line to maintain the length of the horizontal sensing data lines SY₁ to SY_{N} to be constant, differences among the sensing data signals output through the horizontal sensing data lines SY₁ to SY_{N} are reduced, and differences among the sensing signals Vo output through the sensing signal output units SOUT are also reduced. That is, total capacitance including parasitic capacitance between the horizontal sensing data lines SY₁ to SY_{N} and metal layers formed under the horizontal sensing data lines SY₁ to SY_{N} is the same, thereby reducing differences among the sensing data signals output through the horizontal sensing data lines SY₁ to SY_{N}.

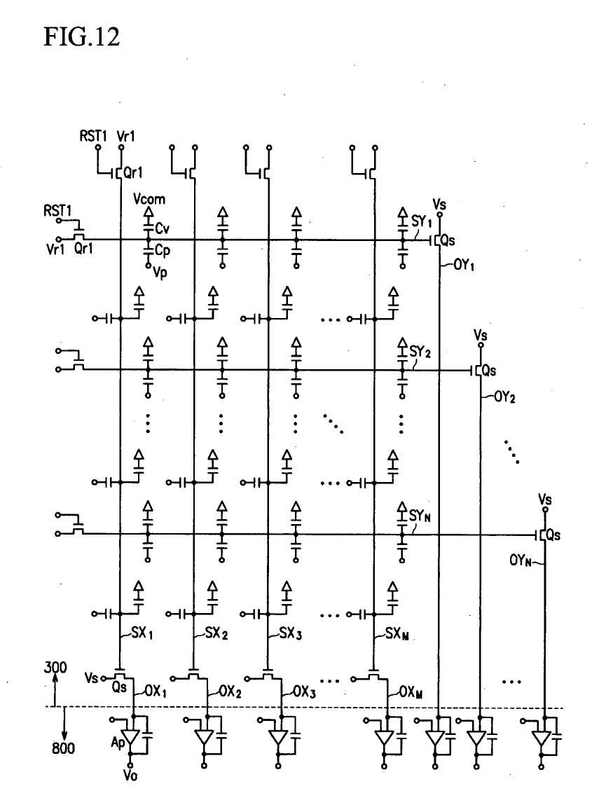

In FIG. 12, like in FIG. 3, the sensing signal output units SOUT and the horizontal output data lines OY₁ to OY_{N} connected thereto are disposed at one side, for example the right side of the liquid crystal panel assembly 300. However, unlike in FIG. 3, the sensing signal output units SOUT may not be vertically located in line. The sensing signal output units SOUT may be vertically located in a horizontally shifted manner at predetermined intervals. Thus, lengths of the horizontal sensing signal lines SY₁ to SY_{N} connected to the sensing signal output units SOUT are different. Although the first horizontal sensing signal line SY₁ is shortest in FIG. 12, on the contrary, the sensing signal output units SOUT and the sensing output data lines OY₁ to OY_{N} may be disposed so that the last horizontal sensing signal line SY_{N} is shortest.

As described above, since the sensing signal output units SOUT and the horizontal output data lines OY₁ to OY_{N} can be disposed on the liquid crystal panel assembly 300 in various manners, the space of the liquid crystal panel assembly 300 can be efficiently used, and a degree of freedom in design increases.

Although the sensing unit including variable capacitor and reference capacitor is used as an example of the sensing unit according to an embodiment of the present invention, the sensing unit is not limited to the aforementioned type of sensing unit, and another type of a sensing element may be used. Specifically, a pressure sensing unit or light sensing unit may be used. The pressure sensing unit has two terminals that are a common electrode of a common electrode panel and a sensing data line of a thin film transistor array panel. At least one of the two terminals is protruded, and accordingly, the terminals are physically and electrically connected to each other due to the user's contact, thereby outputting the common voltage as the sensing data signal. In the light sensing unit, the output signal is changed depending on light intensity.

In addition, the display device according to an embodiment of the present invention may include two or more types of sensing units to improve the accuracy of determining whether the display device is contacted. In addition, although the liquid crystal display is used as the display device according to an embodiment of the present invention, the display device is not limited to the aforementioned type. The display device according to an embodiment of the present invention may be a plasma display device, an organic light emitting diode (OLED) display, and the like.

According to the present invention, the time for integrating the sensing signal is increased by controlling the common voltage, and the reliability of the sensing signal due to noise is increased, thereby improving sensitivity of the sensing unit.

In addition, since the sensing signal output units SOUT and the horizontal output data lines OY₁ to OY_{N} can be disposed in various manners, the space of the liquid crystal panel assembly 300 can be efficiently used, and a degree of freedom in design increases.

While this invention has been described in connection with what is presently considered to be practical exemplary embodiments, it is to be understood that various modifications and equivalent arrangements will be apparent to those skilled in the art and may be made without, however, departing from the spirit and scope of the invention.

What is claimed is:

1. A liquid crystal display comprising:
a first display panel;
a second display panel facing the first display panel and spaced apart from the first display panel;
a liquid crystal layer interposed between the first and second display panels;
a plurality of sensing data lines formed on the second display panel;
a plurality of variable capacitors connected to the sensing data lines and a first voltage, the variable capacitors having a capacitance that is changed depending on pressure;
a plurality of reference capacitors connected to the sensing data lines and a second voltage; and
a plurality of output units connected to the sensing data lines, the output units generating sensing signals on the basis of sensing data signals that flow through the sensing data lines,
wherein the magnitude of the first voltage has a first level and a second level that is different from the first level, and the magnitude of the second voltage is constant, and
wherein the time period for maintaining the first voltage at the second level in a interval for reading the sensing signal is at least 1H, and the sensing signal is generated while maintaining the first voltage at the second level.

2. The liquid crystal display of claim 1, wherein
the second level is higher than the first level.

3. The liquid crystal display of claim 1, wherein
the second level is lower than the first level.

4. The liquid crystal display of claim 1, wherein
the first voltage is a common voltage.

5. The liquid crystal display of claim 4, wherein
the interval for reading the sensing signal is a porch interval.

6. The liquid crystal display of claim 1, further comprising
a plurality of reset signal input units connected to the sensing data lines, the reset signal input units receiving a reset voltage and applying the reset voltage to the sensing data lines.

7. The liquid crystal display of claim 6, wherein
the reset signal input units connected to the sensing data lines each include a first reset switching element which applies the first reset voltage that is input depending on the first reset control signal to the connected sensing data line.

8. The liquid crystal display of claim 7, wherein the reset signal input units connected to the sensing data lines each further include a second reset switching element which applies the second reset voltage that is input depending on the second reset control signal to the connected sensing data line at a different time from that when the first reset voltage is applied.

9. The liquid crystal display of claim 1, further comprising
a plurality of output transistors connected to the sensing data lines, each of the output transistors transmitting an output signal that is generated depending on the sensing data signal that flows through the sensing data line to the corresponding output unit.

10. A liquid crystal display comprising:
a first display panel;
a second display panel facing the first display panel and being spaced apart from the first display panel;
a plurality of pixels formed between the first and second display panels;
a plurality of first sensing units formed between the first and second display panels;
a plurality of second sensing units formed between the first and second display panels;
a plurality of first sensing data lines connected to the first sensing units, the first sensing data lines extending in the horizontal direction on the second display panel;
a plurality of second sensing data lines connected to the second sensing units, the second sensing data lines extending in the vertical direction on the second display panel;
a plurality of first sensing signal output units formed on the second display panel, the first sensing signal output units converting sensing data signals output from the first sensing data lines; and
a plurality of second sensing signal output units formed on the second display panel, the second sensing signal output units converting sensing data signals output from the second sensing data lines,
wherein the plurality of first sensing signal output units are formed at the left or right side of the second display panel.

11. The liquid crystal display of claim 10, further comprising
a plurality of output data lines connected to the plurality of first sensing signal output units.

12. The liquid crystal display of claim 11, wherein
the plurality of first sensing signal output units are vertically disposed in line.

13. The liquid crystal display of claim 12, wherein
the plurality of output data lines extend in the vertical direction.

14. The liquid crystal display of claim 12, wherein
the plurality of output data lines extend between the respective adjacent pixels in the horizontal direction in different lengths and then extend in the vertical direction.

15. The liquid crystal display of claim 12, wherein
the adjacent first sensing signal output units are vertically disposed in a horizontally shifted manner at predetermined intervals.

16. The liquid crystal display of claim 15, wherein
the plurality of output data lines extend in the vertical direction.

17. The liquid crystal display of any one of claims 10 to 16, wherein
the sensing units each include a variable capacitor of which capacitance is changed depending on pressure and a reference capacitor connected to the sensing data line and the second voltage.
